(19) United States
(12) Patent Application Publication
(10) Pub. No.: US 2006/0257598 A1
(43) Pub. Date: Nov. 16, 2006

(54) Fiber assembly

(76) Inventor: Klaus Rennebeck, Wendlingen (DE)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/490,466

(22) Filed: Jul. 20, 2006

Related U.S. Application Data
(63) Continuation of application No. PCT/EP05/00293, filed on Jan. 14, 2005.

(30) Foreign Application Priority Data
Jan. 21, 2004 (DE) 10 2004 004 251.9

(51) Int. Cl. B28B 23/00

(52) U.S. Cl. 428/34.5

(57) ABSTRACT

The invention relates to a fiber assembly (1) comprised of at least two fibers (2, 3), in which at least one first fiber (3), with a laterally open hollow profile, at least partially surrounds a second fiber (2) formed separately from the first fiber, and accommodates, inside its cavity, the second fiber while coming in contact with the second fiber.

### CROSS-REFERENCE TO RELATED APPLICATION

The present application is a continuation of International Application PCT/EP2005/000293, which was filed Jan. 14, 2005. The entire disclosure of International Application PCT/EP2005/000293 is incorporated herein by reference.

### BACKGROUND OF THE INVENTION

The present invention concerns a fiber assembly having at least two fibers.

Fibers consisting of two different materials are known, where these fibers are produced in a single production step and are solidly linked to each other, and where one material is situated on the interior of the second material that is formed with a sickle-like cross section (see EP 0 378 194 B1).

Furthermore, fiber assemblies are known where the individual fibers are essentially parallel to each other and are more or less in contact with each other.

JP 62-110916A describes a fiber assembly where one solid fiber is placed inside a C-shaped hollow fiber with an open side. The method of production is carried out on a fiber with an essentially circular solid profile, by means of dissolution of a soluble contact layer between the solid fiber and the C-shaped hollow fiber, such that a gap remains between the solid fiber and the C-shaped hollow fiber.

Such assemblies of fibers do not fulfill all needs.

### BRIEF SUMMARY OF SOME ASPECTS OF THE INVENTION

The present invention is based on the objective of improving a fiber assembly having at least two fibers. In accordance with an aspect of the present invention, a fiber assembly includes at least one first fiber and at least one second fiber that is separate from the first fiber. The first fiber has a hollow profile that is laterally open, whereby the first fiber defines a hollow space. The hollow profile at least partially surrounds the second fiber so that the second fiber is at least partially positioned in the hollow space. The first fiber is in contact with the second fiber.

According to the invention, a fiber assembly has at least two fibers, where at least one first fiber with a laterally open hollow profile at least partly surrounds a second formed fiber, which is separate from the first fiber, by harboring the second fiber in its (i.e., the first fiber's) hollow space, where the second fiber has contact with the first fiber, preferably close contact along the full extent, preferably specifically in the longitudinal direction at the terminal areas. The second fiber may also be a fiber with a laterally open hollow profile. The second fiber is preferably embodied so that it also has a hollow profile, specifically an open hollow profile, in such a manner that the entire fiber assembly has a closed hollow profile. The invention uses several fibers, preferably fibers with laterally open hollow profiles, to generate a fiber profile defined preferably by a continuous hollow space (lumen) that is open at its ends. There is preferably tension between the fibers, preferably tension in the outer fiber, preferably by elastic deformation. The lateral openings of the hollow profiles are preferably offset with respect to one another, such that two open profiles generate a closed profile, where an open hollow profile surrounds the other hollow profile at least in the vicinity of the opening and makes close contact with the other hollow profile. There is preferably no material connection of the fibers.

Fibers with such a C-shaped profile, as used in an assembly according to the invention, may be molded, extruded or woven and then possibly stretched, such that minimal dimensions down to the micro or even nano fiber level are feasible. If the fibers consist of ceramic material, they may be produced, for example, by the process described in EP 1 015 400 B1 or DE 197 01 751 A1. The C-shaped profile may also be produced by shaving the fiber from a solid block consisting of the original material, much like shaving butter from a block. It is also feasible to use rolls of an appropriately dimensioned foil strip or a foil with subsequent splitting into strips to form the fiber. A fiber with a solid or hollow profile may also be produced by etching. Given the compound nature of the fiber, it is feasible to combine relatively short individual fibers by simple means by offset combinations of the individual fibers into a compound fiber assembly of any length. Beads, flanges etc. are not required for linkages.

Plastic, green or brown ceramic fibers or foils may be surface-treated and can then be tempered, heated, burnt, or sintered in a thermal process and subsequently may be combined into the fiber assembly.

The aggregation of the fibers into the fiber assembly is handled by opening the outer fiber and inserting the inner fiber. The opening and insertion in the case of structures at the micro and nano level relies specifically on the probe of a power microscope, which specifically will have a tip consisting of a single molecule.

It is feasible in principle to dissemble a fiber assembly, to treat the individual fibers and to reassemble them.

If the individual fibers are embodied appropriately, it is also feasible to combine more than two fibers. The outer fiber should be dimensioned in this case such that it will sufficiently surround the adjacent inner fiber.

The advantage of a joined fiber assembly compared to a hollow fiber is specifically that various materials with varying lengths may be combined and that it is simpler to apply structures on the interior mantle surface. This will simplify or in many cases enable an interior coating process, specifically for structures at the micro and nano level.

The fibers may also be treated and/or coated with surface coatings, such as bioactive and/or electrically conductive surface coatings, before or after assembly. Specifically, it is feasible to insert and/or apply electrically conductive structures.

It is thus feasible to use the fiber assembly according to the invention in an appropriate embodiment as a thermal element, specifically as a thermal generator. For example, this may be a bipolar design, specifically with two separated insulation layer sheet foils. The single or multiple thermal elements and the other installation with a height of preferably less than about 100 μm (wall thickness) is situated between the foils, but higher dimensions are also possible. The micro or nano tubes are embodied by a fiber assembly according to the invention, where an appropriate contact is provided. Specifically, two serial thermal elements are envisaged here, where the diameter corresponds to a hydraulically equivalent diameter of about 70 μm, also with textile properties.

The surface temperature of human skin is sensed by direct contact and is compared to the foil temperature of the distant foil (ambient temperature). Electric current is generated by the difference in temperature due to the Seebeck effect. The known foil thermal generators cannot produce such a density in the small space, which means that the textile embodiment of the invention is a significant improvement. Furthermore, the isolating foils under the current state of the art hinder aspiration, if applied directly to human skin, and are thus uncomfortable for the wearer. However, a material produced with the fiber assembly described by this invention, specifically a fabric, will allow the skin to breath, and it will thus significantly improve the comfort level of the wearer, such that even large patches of material with the associated increased electrical output are feasible without negative impact on comfort. Thermal generators generate electric current in a manner particularly free of ecological impacts, without any emissions. The semiconductor material, preferably silicon, is the second most plentiful material in the earth's crust, after oxygen and is thus particularly cheap. Silicon as pure silicon has a particularly high Seebeck coefficient, which is desirable in the use of thermal generators.

Reversal, i.e. the use of an appropriate electrical voltage, permits targeted heating or cooling of certain areas of the material (thermal element).

In terms of electrical power generation from temperature differences, the thermal generating technology is roughly one-thousandth as strong as today's specific solid electrolytes of fuel cell technology, where the fuel cell provides about 10,000 to 15,000 W/m² and also requires air for operation by CₙHₘ oxidation. In comparison, a square meter of silicon thermal generator surface yields 10 to 15 W for a temperature difference of about 5 K.

Preferably, n and p doped thermal generators are applied to electrically isolating textile material and are linked electrically in the textile structure. It is most advantageous that the hollow filament fibers, which, in accordance with the invention, consist of non-organic or organic materials, are attached to synthetic filament fiber surfaces. Nano and micro hollow fibers of nitride ceramics, glass, oxide ceramics and polymers that can be sterilized are preferred.

It is preferable to use silicon and other suitable semiconductor materials as the nano or micro fibers in thermal generators.

The textile materials are preferably hydrophilicly sensitized such that the differences of the aspiration psychometric data of dry sphere and wet sphere temperatures on the thermal generator may also be used for electric power generation. This also facilitates use of the ambient heat (enthalpy) of air in accordance with the h-x diagram differences to generate electric direct current.

It is preferable to use silver or brass in filament fiber form as the electric conductor with suitable physiological and hygienic properties in thermal generators. Silver and brass have fungicidal, bactericidal, and viruscidal properties with good compatibility with human skin. Alternatively, electrically conductive doped diamond or electrically conductive polymers could be used here.

It is advantageous that the n and p doped thermal generators are inserted into the lumen, i.e. into the interior of the fiber assembly, where the fiber assembly exterior surfaces form the insulation of the thermal generators in the filament fiber lumen.

It is preferable that the electric conductor may also be led through the fiber walls, preferably with silver or brass filaments in the nano or micro insulation filament hollow fiber lumen. Other suitable electricity-conducting materials are also possible.

It is advantageous that the fiber assembly circumference is divided into two circumference surfaces, preferably in the direction of the longitudinal axis, such that each fiber forms a portion of the circumference. Geometric longitudinal reinforcements form the reinforcements of the walls and thus influence the heat conductivity. This inventive step separates the insulation circumference into a hot and cold side. It is preferable to have a strip reinforcement on the circumference, which is applied or formed as a longitudinal strip with parallel reinforcements, preferably offset at 180°, to divide the circumference into a cold and a hot side. This is handled preferably by two expansions of the outer fiber.

It is preferable to use materials with silicone in/on the polyvinyl, alcoholate, cellulose, styrene, viscose, acryl, gelatin, gel, sol-gel, and protein nano and micro hollow fibers as carrier surfaces for the n and p doped thermal generators. Zirconium oxide and other oxides are particularly well suited as carrier material, as well as aluminum oxide and mixed oxides, glass, and spinnelides, and as electric conductor also carbon (with or without doping), graphite, carbon black and iron compounds.

The thermal generator is intended to be the energy source for implants, such as hearing aids or vision aids, in another application.

The thermal generator may be surrounded by or may incorporate operating media, such as a heat exchanger, in order to influence or control the cold and hot side of the thermal generator with a view towards power and voltage generation. This can also provide a functional and operational surveillance or control.

Likewise, it is feasible that two fibers form electrodes and surround a solid material electrolyte membrane, which forms a third fiber or which is placed as an elastic foil between the two fibers. This facilitates the use of the fiber assembly as described in this invention in a fuel cell. That will also permit a better optimization of surface coating on the solid material electrolyte, compared to an arrangement with a hollow fiber with a continuous hollow profile.

In another embodiment of the fiber assembly of invention, the inner fiber is filled with a medium and the outer fiber serves as the closure. The lumen is preferably divided into compartments in the longitudinal direction of the fiber assembly, such that the fiber assembly serves as a grouping of storage compartments. This arrangement facilitates a fast determination of the desired dosage amount for an application in the medical field, for example. The desired dosage amount may be separated out in an aseptic manner and may be administered separately, if needed. The separation may be handled by cutting or tearing. To facilitate separation, preferably perforations and/or slits and/or slots or depressions are designed for the space between two compartments to designate where a break should occur. This method facilitates aseptic separation or separate administration. Designated break points for separation may include a specified number of compartments with unique configurations to facilitate separation at these break points. Counting would be unnecessary. Dosage could rather be measured by length or by comparing length to a dosage guide.

In one embodiment, the volume of the compartment varies with a variation of the required dosage, where the change in volume may be handled by a change in the diameter and/or a change in the length of the individual storage compartments connected to each other. If the diameter changes, the dimensions of the fibers in the fiber assembly will change correspondingly. A delay in the release of the drug may be facilitated by a targeted change in the thickness of the wall.

The individual storage compartments, i.e. the fiber assembly, may also contain designated break points through which the material contained in the compartment may be released, if needed. The designated break points may be opened preferentially, for example by an interaction with a specific drug.

The materials introduced into the storage compartments will preferably be biological or medical drugs, as well as preferably homoeopathic drugs or food supplements. The introduction of other materials is also possible. The highly preferable use is for cytostatic or virostatic agents and drugs for defense against external microorganisms. Thus, preferred agents to be contained in the storage compartments include Ribavirin, Azido-Azethyl-Thymidin, carcinoma-static agents, preferably with Spindel, Boswellia Serrata, RFT RAS farnesyl transferase blockers. The storage compartments are also well suited for vaccination, such as for malaria prophylaxis or influenza prophylaxis. It is also possible to use extremely small amounts of drugs, such as for intra-cell administration of substances or to prevent cell division, where the freed DNA and RNA block malignant growth sequentially by the released drug.

The storage compartments may also contain light alloys and/or rare-earth elements and/or salts of light alloys and/or their ions and/or fluorescing drugs and/or phosphorescent drugs and/or sulfonating drugs and/or haematite and/or Magnit and/or Artemisinin and/or ion conductors and/or proton conductors. The use of fluorescing, phosphorescent and/or sulfonating drugs facilitates tracing and may aid the supervision of functions.

The drugs filled into the storage compartments in a fiber assembly and enclosed there are preferably released in a human or animal body. Specifically, it should be possible to determine the reaction time after administration, calculate the effectiveness and administer the drug in vivo or corporal. Intravenous administration, specifically from individual storage compartments, is also possible, just as is oral administration. The storage compartments may also be inserted into a human or animal body, such as in a stent.

It is preferable that the walls surrounding the drugs, i.e. the fiber assembly, consist of lytic material, i.e. dissolvable, peptogenic material, i.e. reversible from gels in salt solution, in synthetic or in natural form.

An additional application provides for a light source with electrodes, where the electrodes and possibly also a reflector are located in a fiber assembly according to the invention, i.e. the radiation source has the form of a fiber assembly. The form of the fiber assembly is not limited specifically. Thus, it is essentially possible to use round fiber assemblies or essentially oval or multi-faceted fiber assemblies.

It is preferable that the fiber assembly has an external diameter or, in the case of non-cylindrical design, a hydraulically equivalent external diameter of 0.1 μm to 100 mm, preferably in the range of 5 μm to 200 μm. For these dimensions, it is feasible to use fiber assemblies with textile properties, such that the radiation source may be bundled, such as knitted or woven. It is feasible here to use such a precise knitting or weaving pattern that the light may extrude on only one side of the material, specifically if the fiber assembly is appropriately “flat.”

The fiber assembly has a light port, which is preferably formed by the fibers and is preferably coated with phosphor. It is also feasible to use a coating with other materials. However, the coating could also cover the entire interior surface of the fiber assembly. Specifically, it is feasible to use a coating with 1-3 atom layers of platinum or other elements of the 8 subgroup, which will have fluorescent properties in this layer thickness. It is preferable to use a non-conducting material in the area of the electrodes. It is preferable here that the non-conducting material have small openings, specifically holes in the nano range.

It is preferable that the electrodes consist of molybdenum or an element of the 8 subgroup. The electrodes may also consist of doped carbon, specifically doped diamond, or of electrically conductive polymers.

It is preferable that the fiber consist of SiO₂+Al₂O₃, specifically glass, ceramics, china, doped carbon, diamond, sapphire, leukosaphire, opal, emerald, spinell, zircon oxide, polyester, polymer, fluorinated polymer, PTFE, PEEK, Makrolon, or acrylic glass.

The reflector consists preferably of anodic oxide, silver, aluminum, or platinum. It covers preferably at least half of the interior surface of the fiber assembly, where the reflector extends particularly in the longitudinal direction of the fiber assembly. A reflector is required specifically for applications as a laser. If the light emission is not intended to be bundled, a reflector may be omitted and essentially the entire circumference of the fiber assembly may be used as the light port.

Such fiber assemblies may be used for infrared light sources, UV light sources or laser light sources. Such fiber assemblies, specifically in the form of UV light sources, may be used in the production of aseptic table surfaces in operating rooms, among other uses. The fiber assemblies may be spatially knitted or woven and subsequently encased, for example. Knitting may generate spatial forms, such as honeycombs, which are then fixed by means of a transparent poured material and are covered at top and/or bottom by nontransparent prepregs (sandwich honeycomb), where fiber assemblies may also be designed into the prepregs. Such hollow bodies have a low weight at high density.

Likewise, it is possible to produce aseptic curtains, bags, tents, cloths or bandages, where the fiber assemblies may be embodied as UV light sources, for example. For example, this could provide a bandage that could hold the body temperature of a critically wounded person at a constant level.

It is also possible to use such fiber assemblies for the integrated lighting of roofs, roof elements, ceilings, indirect room lighting, signs or advertising signage, displays, keyboards, curtains, blinds, tarps, covers, textiles, etc.

It is possible to use such fiber assemblies in devices to sterilize air, water, foodstuffs or blood, such as in external blood UV therapies, such as are used specifically in the treatment of cancer. Devices with such fiber assemblies may be inserted into veins or percutaneously, and they may be supplied with electrical energy by means of a time-dependent control mechanism. If the entire treatment device is equipped with appropriate light sources, it is possible to assure an aseptic treatment, specifically if blood is involved.

Appropriate devices may also treat the materials to be processed by ozonation, ionization and/or electrical charging, in addition to killing germs.

The fiber assemblies may be framed for better handling, which is appropriate for small diameters.

The production of fibers for such fiber assemblies may be handled by means of a multiple component spinning jet, where specifically the electrodes and the non-conducting material may be inserted directly into the fiber.

In a different production process, a complete fiber assembly is ionized in sections, such that material may be targeted for deposition in such areas.

It is also feasible to undertake a wet-chemical coating, possibly by relying on surface tension to generate structures, such as the electrodes. In this process, a vacuum is generated on a side of the fiber assembly, such that a liquid is drawn into the fiber assembly, which is then deposited on the walls or on sections of the walls.

The requirements normally do not create special issues relating to the adhesion of a potentially designated reflector on the interior surface of the fiber assembly.

Given appropriate design, the fiber assembly may be used to create a bionic organ replacement, where specifically cell cultures may be bred on the outer surface of the fiber assembly. Reference is made in this regard to WO 00/06218.

Likewise, the use in accordance with DE 199 08 863 A1 as a device to generate synthetic gas and in accordance with DE 100 16 591 C2 as a device to generate hydrogen is feasible.

After assembly, the fiber assembly may be treated or processed such that the individual fibers are in solid contact with each other, such as with strong adhesive force. A seam on the wall circumference may also be included.

It is preferable that at least one fiber of the fiber assembly has an external diameter or hydraulically equivalent external diameter of less than 1 mm, specifically of 5 μm to 500 μm, which means that this involves preferably so-called micro fibers or even nano fibers, where specifically the fiber assembly forms a micro hollow fiber or nano hollow fiber.

The fibers preferably will have walls of essentially constant thickness, where the walls may have segments with protuberances or saw tooth extensions, such that textile properties may be enabled or supported.

The fiber assembly preferably will have a hollow profile that extends throughout the entire length of the fibers.

A number of fiber assemblies according to this invention with textile properties are preferably combined into a textile material, specifically a weave, a knit or a fleece. One, several, or many fiber assemblies may combine into a thread. Particularly in cases involving an article of clothing, use of mixed fibers or joint processing with conventional fibers is also feasible.

Other aspects and advantages of the present invention will become apparent from the following.

### BRIEF DESCRIPTION OF THE DRAWINGS

In the following, the invention will be further explained, in part by references to the attached drawings, with reference to exemplary embodiments. In the drawings:

FIG. 1 is a schematic view with substantial enlargement of a cross section through a fiber assembly according to the first exemplary embodiment, where the cross section is taken along line I-I of FIG. 2, and only the cross section is shown,

FIG. 2 is a partial view with substantial enlargement along the longitudinal axis of the fiber assembly of FIG. 1, and

FIG. 3 are various views of cross sections through fiber assemblies according to the invention with substantial schematic simplification.

### DETAILED DESCRIPTION OF EXEMPLARY EMBODIMENT

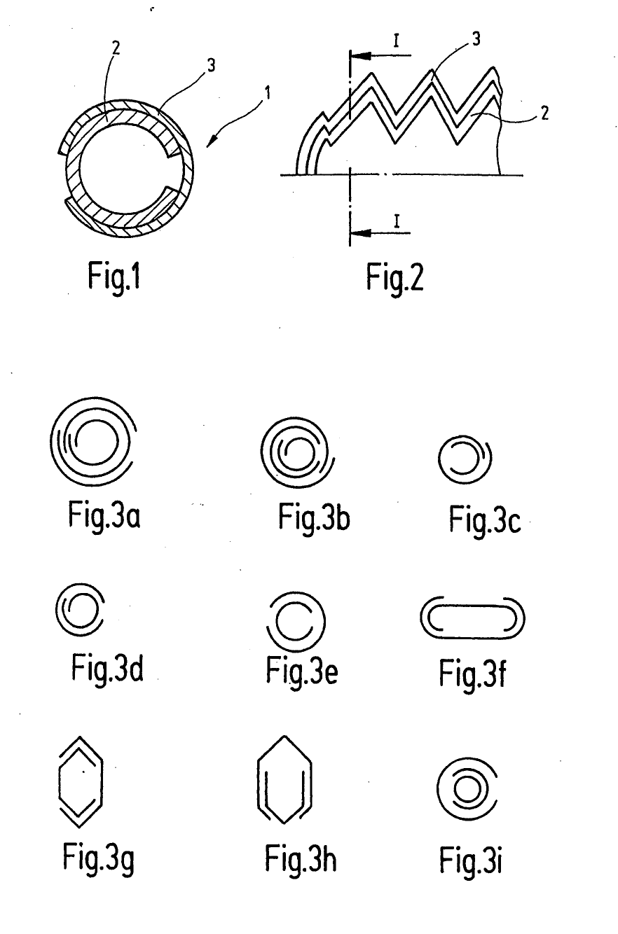

FIG. 1 shows a cross section through a fiber assembly 1 with two fibers 2, 3. The fibers 2, 3 are embodied as two open hollow fibers, each of which has a C-shaped cross section, where the open sides of fibers 2 and 3 point in opposite directions. In this instance, the outer fiber 3 surrounds or encloses more than half of the inner fiber 2, i.e. such that it is encased in the hollow space defined by the hollow profile of outer fiber 3 and is held in place by the ends of the profile of fiber 3. Fiber assembly 1 has a continuous hollow profile due to the opposite arrangement of the two fibers 2 and 3 and due to the outer fiber 3 partially surrounding the inner fiber 2. In the present case, there is no adhesion between fibers 2 and 3, but the connection is strong due to the contact along the outer edges of outer fiber 3, the friction in the areas of contact and the spring action of outer fiber 3. In the present case, the connection between the two fibers 2 and 3 is so strong that even a certain amount of difference in the pressure between a fluid flowing in the interior space and a fluid flowing along the outside of fiber assembly 1 will not lead to an exchange or mixing of the fluids.

The dimensions of fibers 2 and 3 match, where both fibers 2 and 3 in separate and unmodified condition have an essentially hollow cylindrical design with an opening angle of about 45° and an average outer diameter of about 0.5 mm and a wall thickness of about 0.05 mm.

As FIG. 2 shows, both fibers 2 and 3 have such a folded shape throughout the longitudinal direction that they have textile properties, i.e. such that they may be linked. The outer (and inner) diameter varies here by +/−0.1 mm, i.e. the maximum outer diameter is 0.6 mm and the minimum inner diameter is 0.4 mm, where the wall thickness is essentially unchanged. The folded longitudinal shape also precludes any shifts against each other in a longitudinal direction.

In a second embodiment, not shown in the figures, a fiber with a small opening along its long side with an oval hollow profile is combined into a fiber assembly with a matching open fiber with somewhat smaller dimensions. Both fibers have here an essentially constant profile throughout their lengths. The maximum outer diameter of the outer hollow fiber is about 0.1 mm, the minimum outer diameter of the outer hollow fiber is about 0.05 mm and the wall thickness is about 0.01 mm. The maximum outer diameter of the inner hollow fiber is about 0.99 mm, the minimum outer diameter of the inner hollow fiber is about 0.04 mm, such that the dimensions are equal to the dimensions of the outer fiber less one thickness of the wall. Here several matching outer hollow fibers and inner fibers are arrayed end-to-end, where the joints of the adjoining outer and adjoining inner hollow fibers are offset with respect to each other, such that an endless fiber assembly may result in principle.

In a third embodiment, which is also not shown in the figures, the inner fiber is embodied as a C-shaped open hollow profile, where the ends are essentially parallel to each other. The outer fiber is shaped such that it surrounds the inner fiber in accordance with the previously described exemplary embodiments. In this case, the inner fiber is filled with a substance and the outer fiber serves as the closure.

In a first example of the third embodiment, the two fibers, presently micro fibers, consist of lytic material, where the inner fiber has a hydraulically constant interior diameter of about 15 μm and a wall thickness of about 5 μm, and where the outer fiber is slightly larger. This inner fiber is filled with cytostatic material and is closed by means of the outer fiber. Subsequently, the previously continuous interior hollow space is deformed with a spacing of 50 μm by a deformation process that presses the opposite walls against each other such that numerous separate but connected storage compartments are formed. The change in diameter, i.e. the widening, due to the deformation is not shown. The individual storage compartments may be separated without damaging the compartments and exuding materials from the compartments. The contact area is appropriately designed for this end, possibly even by addition of a perforation or the like.

In a second example of the third embodiment, a peptogenic foil is cut and rolled such that it forms a fiber with a C-shaped profile covered by an appropriate fiber. The inner fiber contains a medical drug or a food supplement. The subdivision into individual storage compartments is identical to the above embodiment.

In the present case, all of the embodiments described above have an outer fiber that covers an adjacent inner fiber in such a manner that the two fibers create a continuous hollow profile in the longitudinal direction that is closed to the outside.

FIGS. 3a to 3i show examples of various cross sections of fiber assemblies according to the invention, where in each case the innermost fiber may also be a solid fiber or a fiber with an open or closed hollow profile. In this case, the inner fiber may also be filled with another material and/or another fiber, for example.

It will be understood by those skilled in the art that while the present invention has been discussed above with reference to exemplary embodiments, various additions, modifications and changes can be made thereto without departing from the spirit and scope of the invention as set forth in the following claims.

What is claimed is:

1. A fiber assembly, comprising:
at least one first fiber, wherein the first fiber has a hollow profile that is laterally open, whereby the first fiber defines a hollow space; and
at least one second fiber that is separate from the first fiber, wherein
the hollow profile at least partially surrounds the second fiber so that the second fiber is at least partially positioned in the hollow space, and
the first fiber is in contact with the second fiber.

2. The fiber assembly of claim 1, wherein the second fiber has a hollow profile.

3. The fiber assembly of claim 1, wherein the fiber assembly as a whole has a closed hollow profile.

4. The fiber assembly of claim 1, wherein:
the first fiber has an outer diameter or hydraulically equivalent outer diameter of less than 1 mm, and
the second fiber has an outer diameter or hydraulically equivalent outer diameter of less than 1 mm.

5. The fiber assembly of claim 1, wherein:
the first fiber has a length and a wall thickness,
the wall thickness of the first fiber is substantially constant over the length of the first fiber,
the second fiber has a length and a wall thickness, and
the wall thickness of the second fiber is substantially constant over the length of the second fiber.

6. The fiber assembly of claim 1, wherein:
the first fiber and the second fiber each define at least one shape selected from the group consisting of a folded-like shape and a saw tooth-like shape,
the first fiber has a length, a diameter, and a substantially constant wall thickness,
the diameter of the first fiber varies along the length of the first fiber such that the first fiber has textile properties,
the second fiber has a length, a diameter, and a substantially constant wall thickness, and
the diameter of the second fiber varies along the length of the second fiber such that the second fiber has textile properties.

7. The fiber assembly of claim 1, wherein at least a portion of a fiber that is selected from the group consisting of the first fiber and the second fiber includes at least one material selected from the group consisting of glass, ceramics, china, doped carbon, diamond, sapphire, leukosaphire, opal, emerald, spinell, zirkon oxide, polyester, polymer, fluoridated polymer, PTFE, PEEK, Makrolon, acrylic glass, lytic material, and peptogenic material.

8. The fiber assembly of claim 1, wherein at least a portion of a fiber that is selected from the group consisting of the first fiber and the second fiber is electrically conductive.

9. The fiber assembly of claim 1, wherein at least a portion of a fiber that is selected from the group consisting of the first fiber and the second fiber is electrically non-conductive.

10. The fiber assembly of claim 1, wherein the first fiber being in contact with the second fiber comprises there being electrical contact between the first fiber and the second fiber.

11. The fiber assembly of claim 1, wherein:
the at least one first fiber comprises there being several first fibers,
the at least one second fiber comprises there being several second fibers,
the first fibers and the second fibers are respectively connected and offset in a longitudinal direction in such a manner that the first fibers and the second fibers together form the fiber assembly so that the fiber assembly
(a) has a substantially continuous profile,
(b) has a length that extends in the longitudinal direction,
(c) is longer than each of the first fibers, and
(d) is longer than each of the second fibers.

12. The fiber assembly of claim 2, wherein the fiber assembly as a whole has a closed hollow profile.

13. The fiber assembly of claim 12, wherein:
the first fiber has an outer diameter or hydraulically equivalent outer diameter of less than 1 mm,
the second fiber has an outer diameter or hydraulically equivalent outer diameter of less than 1 mm,
the first fiber has a length and a wall thickness,
the wall thickness of the first fiber is substantially constant over the length of the first fiber,
the second fiber has a length and a wall thickness, and
the wall thickness of the second fiber is substantially constant over the length of the second fiber.

14. The fiber assembly of claim 1, wherein:
the first fiber has an outer diameter or hydraulically equivalent outer diameter that is in a range of 5 μm to 500 μm, and
the second fiber has an outer diameter or hydraulically equivalent outer diameter that is in a range of 5 μm to 500 μm.

15. The fiber assembly of claim 2, wherein:
the first fiber has an outer diameter or hydraulically equivalent outer diameter of less than 1 mm, and
the second fiber has an outer diameter or hydraulically equivalent outer diameter of less than 1 mm.

16. The fiber assembly of claim 2, wherein:
the first fiber has a length and a wall thickness,
the wall thickness of the first fiber is substantially constant over the length of the first fiber,
the second fiber has a length and a wall thickness, and
the wall thickness of the second fiber is substantially constant over the length of the second fiber.

17. The fiber assembly of claim 3, wherein:
the first fiber has a length and a wall thickness,
the wall thickness of the first fiber is substantially constant over the length of the first fiber,
the second fiber has a length and a wall thickness, and
the wall thickness of the second fiber is substantially constant over the length of the second fiber.

18. The fiber assembly of claim 2, wherein:
the first fiber and the second fiber each define at least one shape selected from the group consisting of a folded-like shape and a saw tooth-like shape,
the first fiber has a length, a diameter, and a substantially constant wall thickness,
the diameter of the first fiber varies along the length of the first fiber such that the first fiber has textile properties,
the second fiber has a length, a diameter, and a substantially constant wall thickness, and
the diameter of the second fiber varies along the length of the second fiber such that the second fiber has textile properties.

19. The fiber assembly of claim 3, wherein:
the first fiber and the second fiber each define at least one shape selected from the group consisting of a folded-like shape and a saw tooth-like shape,
the first fiber has a length, a diameter, and a substantially constant wall thickness,
the diameter of the first fiber varies along the length of the first fiber such that the first fiber has textile properties,
the second fiber has a length, a diameter, and a substantially constant wall thickness, and
the diameter of the second fiber varies along the length of the second fiber such that the second fiber has textile properties.

20. The fiber assembly of claim 8, wherein at least a portion of a fiber that is selected from the group consisting of the first fiber and the second fiber is electrically non-conductive.
